(19) United States
(12) Patent Application Publication
(10) Pub. No.: US 2017/0337489 A1
(43) Pub. Date: Nov. 23, 2017

(54) METHOD AND SYSTEM FOR FACILITATING A SIMULATION OF A BUSINESS

(71) Applicant: Michael Ramey Porter, Nashville, TN (US)

(72) Inventor: Michael Ramey Porter, Nashville, TN (US)

(21) Appl. No.: 15/603,201

(22) Filed: May 23, 2017

Related U.S. Application Data
(60) Provisional application No. 62/340,077, filed on May 23, 2016.

(51) Int. Cl. G06Q 10/06; G06Q 10/08; G06Q 40/02; G06Q 40/00

(52) U.S. Cl. CPC G06Q 10/067; G06Q 40/10; G06Q 10/087; G06Q 40/025

(57) ABSTRACT

Disclosed is a computer-implemented method of facilitating a simulation of a business. The computer-implemented method includes receiving, using a processor, multiple business decisions corresponding to the business. Further, the computer-implemented method includes receiving, using the processor, a time period corresponding to the simulation. Yet further, the computer-implemented method includes calculating, using the processor, one or more business variables based on the multiple business decisions and the time period. Moreover, the computer-implemented method includes presenting, using the processor, the one or more business variables.

The current application claims a priority to the U.S. Provisional Patent application Ser. No. 62/340,077 filed on May 23, 2016.

### FIELD OF THE INVENTION

The present disclosure relates generally to simulation. More specifically, the present disclosure relates to a method and a system for facilitating a simulation of a business.

### BACKGROUND OF THE INVENTION

Small business startups and small business owners often use Pro Forma financial projections. Pro formas often give rise to financial projections that make use of unrealistic data or decisions that may be inconsistent. Many startups launch businesses based on expectations of magnificent profits only to discover later the unpleasant realities identified by the actual accounting. When these realities are considered, it is easier to understand why so many startups fail within their first year.

Therefore, people that produce or read pro forma financials have reason to be skeptical of their figures and they tend to be careful not to be over-enthusiastic about the results. In most cases, pro forma figures may differ greatly from those derived by GAAP (Generally Accepted Accounting Principles).

Therefore, there is a need for improved methods and systems that provide better predications about a business.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

Disclosed is a computer-implemented method of facilitating a simulation of a business. The computer-implemented method includes receiving, using a processor, multiple business decisions corresponding to the business. Further, the computer-implemented method includes receiving, using the processor, a time period corresponding to the simulation. Yet further, the computer-implemented method includes calculating, using the processor, one or more business variables based on the multiple business decisions and the time period. Moreover, the computer-implemented method includes presenting, using the processor, the one or more business variables.

According to some aspects, a system for facilitating a simulation of a business is disclosed. The system includes a communication device configured to receive multiple business decisions corresponding to the business, receive a time period corresponding to the simulation, and transmit one or more business variables. Further the system includes a processing device configured to calculate the one or more business variables based on the multiple business decisions and the time period.

According to some aspects, a computer program is disclosed that delivers realistic and actionable financial objectives needed to write a competent business plan. The computer program is designed specifically for small business startups and small business owners. Further, the computer program simulates the actual financial processes that occur within a small business. It enables the operator to reproduce or represent, under test conditions, phenomena likely to occur in actual performance. The computer program may be based entirely on GAAP, so its figures can be given to accountants or bankers for review. The computer program may provide a very realistic and accurate imitation of real-life business financial processes. It accomplishes this because its financial calculations are fully integrated and based entirely on GAAP principles rather than perfunctory pro-forma expectations. Any overly ambitious entry or poorly chosen assumption entered anywhere in the calculations will have an equally bad effect on the income statement and balance sheet. The resulting calculations will tell you if your idea can work or not. If not, it helps a user identify the problem so that they can adjust it. Then, with the click of a mouse, the user can try the simulation again.

According to some aspects, a user may be able to analyze the effects of a future business decision on future cash flow. In addition, the computer program is designed to analyze business decisions and generate reports or suggestions that enable the user to optimize cash flow.

According to some aspects, an educational tool that a new entrepreneur, an existing business owner or a business manager can use to aid their understanding of business processes is disclosed.

According to some aspects, the disclosed method, system and computer program provides accurate and realistic financial simulations that bankers and venture capitalists may find more meaningful and significant. Further, entrepreneurs, existing business owners, and business managers may use to make better financial decisions.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates an exemplary environment in which embodiments of the present disclosure may be implemented.

FIG. 2 illustrates a block diagram of a system for facilitating a simulation of a business in accordance with some embodiments.

FIG. 3 illustrates a flowchart of a computer-implemented method of facilitating a simulation of a business, in accordance with some embodiments.

FIG. 4 illustrates a flowchart of a computer-implemented method of facilitating a simulation of a business, in accordance with some embodiments.

FIG. 5 illustrates a block diagram of multiple engines of a computer program for facilitating a simulation of a business in accordance with some embodiments.

FIG. 6 illustrates an exemplary computing system that may be employed to implement processing functionality for various embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of simulating a business, embodiments of the present disclosure are not limited to use only in this context. For example, the disclosed techniques may be used to rank other items that are given out for rent or sale.

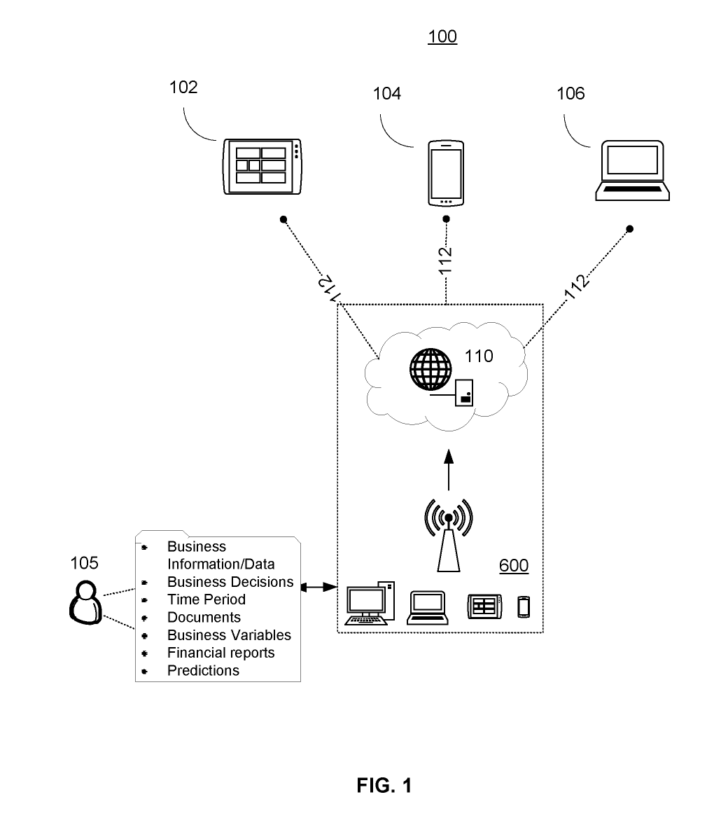

FIG. 1 is an illustration of a platform 100 consistent with various embodiments of the present disclosure. By way of non-limiting example, the platform 100 for simulating a business may be hosted on a centralized server 110, such as, for example, a cloud computing service. The centralized server 110 may communicate with other network entities, such as, for example, a mobile device (such as a smartphone, a laptop, a tablet computer etc.) and other electronic devices (such as desktop computers, etc.) over a communication network 112, such as, but not limited to, the Internet. Further, users of the platform may include one or more relevant parties such as, business owners, investors and administrators of the disclosed systems and platforms. Accordingly, electronic devices operated by the one or more relevant parties may be in communication with the platform. For example, the platform may be in communication with a business owner electronic device 102 operated by the business owner, an investor electronic device 104 operated by the investor and an administrator electronic device 106 operated by the administrator.

A user 105, such as the one or more relevant parties, may access the platform 100 through a software application. The software application may be embodied as, for example, but not be limited to, a website, a web application, a desktop application, and a mobile application compatible with a computing device 600.

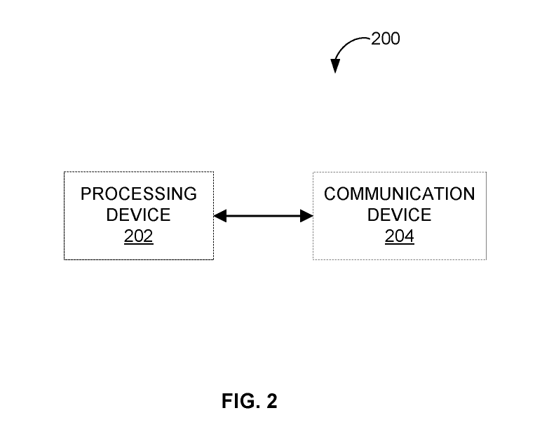

Turning to FIG. 2, a system 200 for facilitating a simulation of a business is illustrated, in accordance with some embodiments. As shown, the system 200 includes a communication device 202 and a processing device 204.

The communication device 202 may be configured to receive multiple business decisions corresponding to the business. For example, the multiple business decisions may include data associated with two or more of tax, inventory, employees, Cost of Goods Sold (COGS), loan, expenses, and revenue.

In some embodiments, the processing device 204 may be further configured to analyze one or more documents corresponding to the business, and extract the multiple business decision based on the analyzing.

However, in some embodiments, the processing device 204 may be further configured to generate one or more queries based on the multiple business decisions, wherein the communication device 202 may be further configured to transmit the one or more queries to one or more databases and receive a result of executing the one or more queries, wherein calculating the one or more business variables may be based on a result of executing the one or more queries.

Further, the communication device 202 may be configured to receive a time period corresponding to the simulation. For example, a business owner may provide a time period for which she wants to run a simulation.

In some embodiments, the communication device 202 may be further configured to transmit a user interface to a user, wherein the user interface may be configured to receive the multiple business decisions. Further, the user interface may be further configured to receive the time period.

Yet further, the communication device 202 may be configured to transmit one or more business variables. For example, the one or more business variables may include one or more of a cash flow, a financial deficit, a tax bracket and one or more Cost of Goods Sold (COGS) associated with one or more products of the business. Further, the one or more business variables may further include an allowable maximum money expendable on direct materials associated with each product of the multiple products. Yet further, the one or more business variables comprises multiple COGS corresponding to multiple products. The multiple COGS may be calculated based on multiple individual costs corresponding to the multiple products and one or more shared costs corresponding to the multiple products.

The processing device 204 may be configured to calculate the one or more business variables based on the multiple business decisions and the time period.

The processing device 204 may be further configured to associate multiple categories to the multiple business decisions, wherein the calculation of the one or more business variables is performed based on the multiple categories.

According to some embodiments, the processing device 204 may be further configured to analyze each of the multiple business decisions and the one or more business variables. The processing device 204 may be further configured to generate one or more suggested business decisions based on analyzing the one or more business variables.

According to some embodiments, the communication device 202 may be further configured to receive one or more modified business decisions, wherein the processing device 204 may be configured to calculate the one or more business variables further based on the one or more modified business decisions.

According to some embodiments, the processing device 204 may be further configured to generate a business plan corresponding to the business based on each of the multiple business decisions, the time period and the one or more business variables.

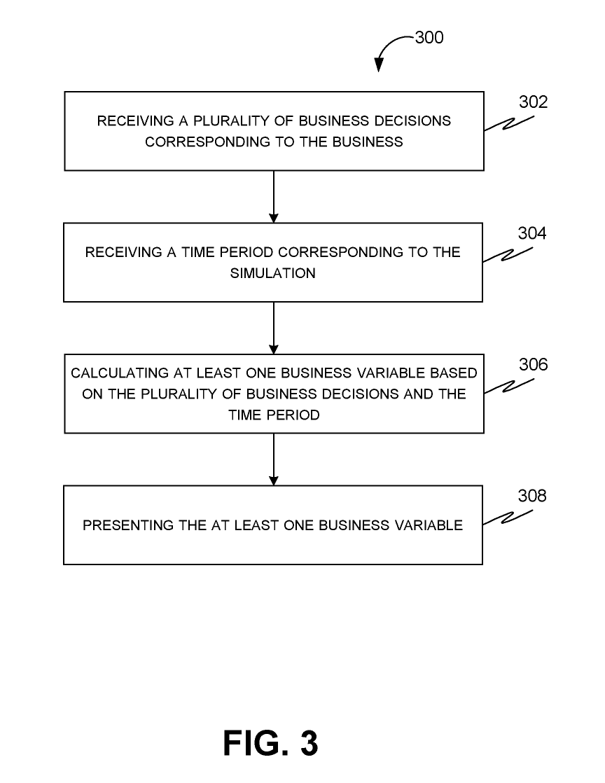

FIG. 3 illustrates a flowchart of a computer-implemented method 300 of facilitating a simulation of a business, in accordance with some embodiments. At 302, the method 300 may include receiving, using a processor, multiple business decisions corresponding to the business. The processor may be the processing device 204. For example, the multiple business decisions may include data associated with two or more of tax, inventory, employees, Cost of Goods Sold (COGS), loan, expenses and revenue.

In some embodiments, the method 300 may include presenting, using the processor, a user interface to a user, wherein the user interface may be configured to receive the multiple business decisions. Further, the user interface is further configured to receive the time period.

In some embodiments, the method 300 may include analyzing, using the processor, one or more documents corresponding to the business and extracting, using the processor, the multiple business decision based on the analyzing. Further, the analyzing may be performed based on natural language processing in order to accurately identify relevant data corresponding to the business decisions. For example, the one or more documents may include a pro forma business plan and presentation slides.

At 304, the method 300 may include receiving, using the processor, a time period corresponding to the simulation.

At 306, the method 300 may include calculating, using the processor, one or more business variables based on the multiple business decisions and the time period. The one or more business variables may include one or more of a cash flow, a financial deficit, a tax bracket and one or more Cost of Goods Sold (COGS) associated with one or more products of the business. The one or more business variables may include multiple COGS corresponding to multiple products, wherein the multiple COGS is calculated based on multiple individual costs corresponding to the multiple products and one or more shared costs corresponding to the multiple products. The one or more business variables may further include an allowable maximum money expendable on direct materials associated with each product of the multiple products.

The method 300 may further include associating, using the processor, multiple categories to the multiple business decisions, wherein the calculating (at 306) may be performed based on the multiple categories.

Further, the method 300 may include receiving, using the processor, one or more modified business decisions, wherein calculating (at 306) the one or more business variables may be further based on the one or more modified business decisions.

In some embodiments, the method 300 further includes generating, using the processor, one or more queries based on the multiple business decisions and executing the one or more queries over one or more databases comprising one or more of regulatory data and market data associated with the business Further, the calculating (at 306) the one or more business variables may be based on a result of executing the one or more queries. Therefore, the method 300 may include automatically querying relevant data sources online in order to obtain the latest data pertinent to calculating one or more output business variables. Such data may include regulatory data (that may be location or jurisdiction specific) and market data.

Thereafter, at 308, the method 300 may include presenting, using the processor, the one or more business variables.

Further, the method 300 may include analyzing, using the processor, each of the multiple business decisions and the one or more business variables. Further, the method 300 may include generating, using the processor, one or more suggested business decisions based on analyzing the one or more business variables.

Further, the method 300 may include generating, using the processor, a business plan corresponding to the business based on each of the multiple business decisions, the time period and the one or more business variables. The business plan may include a structured report including various sections. Further, the business plan may include text and one or more images including charts).

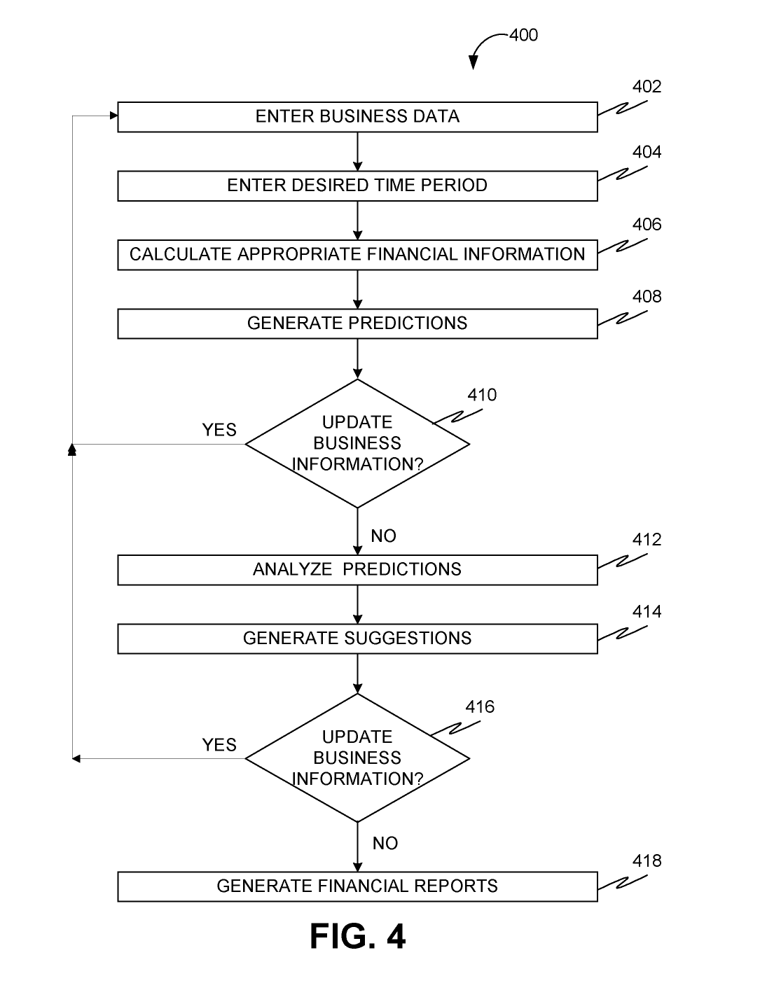

FIG. 4 illustrates a flowchart of a computer-implemented method 400 of facilitating a simulation of a business, in accordance with some embodiments. A processor such as the processing device 204 may implement the method 400. At 402, a business owner may provide business data. The business data may include multiple business decisions corresponding to the business. Then, at 404, a business owner may enter a desired time period. Next, at 406, the method 400 includes calculating an appropriate financial information, such as one or more business variables. Thereafter, at 408, the method 400 includes generating predictions.

Next, at 410, the business owner may update business information based on the financial information. If the business information is updated, then the method 400 goes back to step 402. However, if the business information is not updated, then the method 400 includes analysing predictions at 412. Further, the method 400 includes generating suggestions for the business owner at 414. Therefore, at 416, the business owner may update business information based on the generated suggestions. If the business information is updated, then the method 400 goes back to step 402. However, if the business information is not updated, then the method 400 includes generating financial reports at 418.

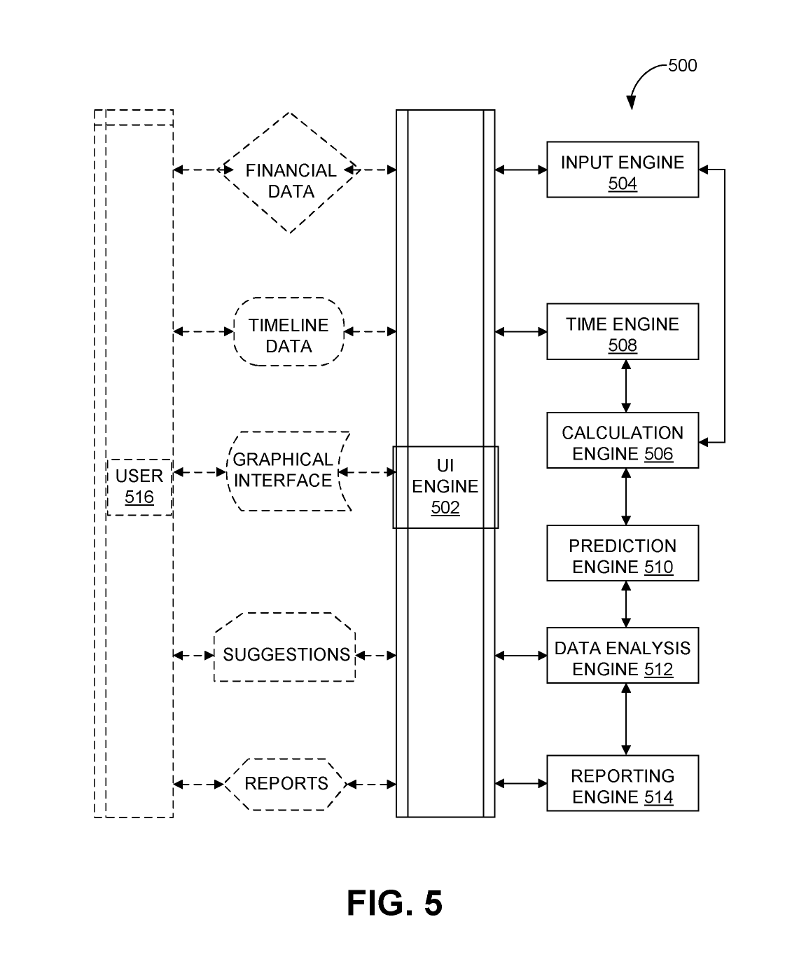

FIG. 5 illustrates a block diagram of multiple engines 502-514 of a computer program for facilitating a simulation of a business in accordance with some embodiments. The computer program may employ user financial data and generally accepted accounting principles (GAAP) to predict the future cash flow of a business. The computer program may be named small business simulator.

The computer program may include a user interface (UI) engine 502, an input engine 504, a calculation engine 506, a time engine 508, a prediction engine 510, a data analysis engine 512, and a reporting engine 514. The term engine is used herein to refer to collections of programs which are grouped based upon function.

According to some embodiments, the computer program may enable a user 516 to visualize the effects a business decision on the cash flow at a future date. The term business decision is used herein to describe changes to variables such as the cost of goods and services (COGS), the number and type of available products, employees, and the like.

The UI engine 502 may be configured to relay information between the user 516 and the various engines 504-514 of the computer program. The UI engine 502 may generate graphical interfaces and enable the user 516 to input data, commands, and preferences. The user 516 may interact with the UI engine 502 while providing business data to the input engine 504. The input engine 504 may be configured to categorize the data input by the user 516. The user 516 may provide information about business decisions, such as taxes, inventory, employees, COGS, loans, expenses, and revenue, to the input engine 504 through the UI engine 502. The input engine 504 may then categorize this data and then passes it to the calculation engine 506.

Further, the calculation engine 506 may be configured to calculate cash flow and financial deficits based on the information entered into the input engine 504. The user 516 may then direct the calculation engine to perform calculations relating to tax brackets, COGS, and available products. Further, the user 516 may interact with the time engine 508 to select the length of time over which the prediction engine 510 will operate. The data from the calculation engine 506 and time engine 508 may be passed to the prediction engine 510, where it may be used to form a realistic model of the business as time progresses.

The prediction engine 510 may generate incremental predictions of a businesses' future. Therefore, the user 516 may update business decisions at any point within a predicted timeline. As a result, the user 516 is able to view how disasters, low cash flow, or surges in popularity will affect future revenue.

Then, the data generated by the prediction engine 510 may be passed to the data analysis engine 512. The data analysis engine 512 may be used to generate suggestions of how cash flow may be increased by enacting various business decisions. Further, the data analysis engine 512 may alert the user 516 of projected cash flow shortfalls and makes suggestions to acquire additional loans or investors. Finally, the reporting engine 514 may be configured to generate charts and detailed financial sheets.

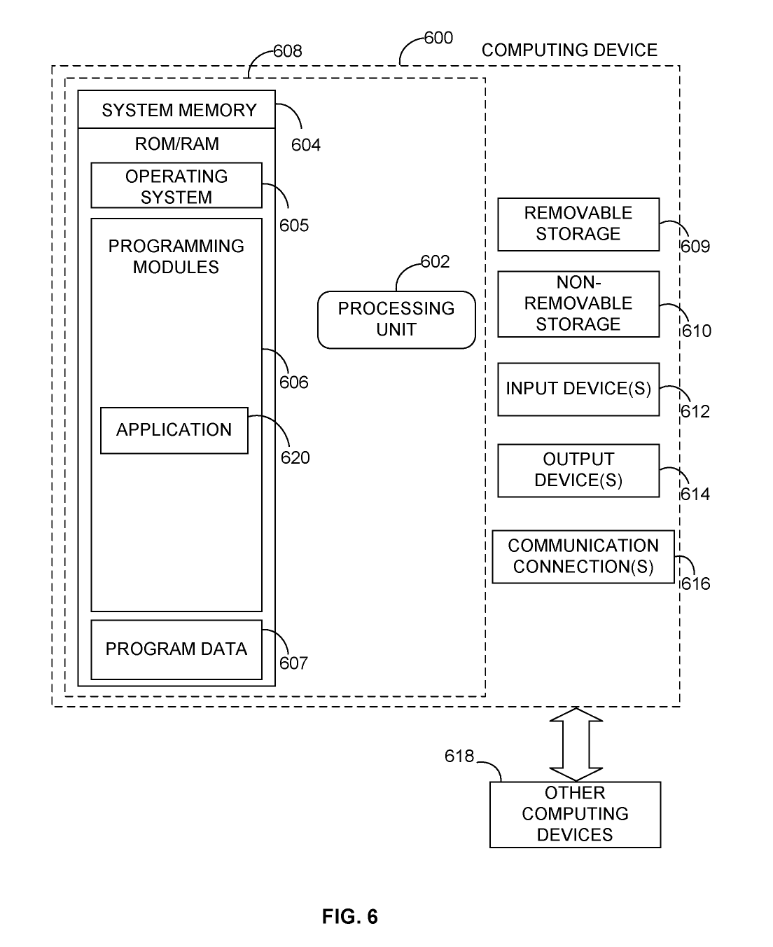

FIG. 6 is a block diagram of a system including computing device 600. Consistent with an embodiment of the disclosure, the aforementioned memory storage and processing unit may be implemented in a computing device, such as computing device 600 of FIG. 6. Any suitable combination of hardware, software, or firmware may be used to implement the memory storage and processing unit. For example, the memory storage and processing unit may be implemented with computing device 600 or any of other computing devices 618, in combination with computing device 600. The aforementioned system, device, and processors are examples and other systems, devices, and processors may comprise the aforementioned memory storage and processing unit, consistent with embodiments of the disclosure.

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., application 620) may perform processes including, for example, one or more stages of methods 300 and 400 as described above. The aforementioned process is an example, and processing unit 602 may perform other processes. Other programming modules that may be used in accordance with embodiments of the present disclosure may include image encoding applications, machine learning application, image classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

### DETAIL DESCRIPTIONS OF THE EMBODIMENTS

A computer-implemented method of facilitating a simulation of a business is provided. The computer-implemented method may include receiving, using a processor, a plurality of business decisions corresponding to the business. Further, the computer-implemented method may include receiving, using the processor, a time period corresponding to the simulation. Furthermore, the computer-implemented method may include calculating, using the processor, at least one business variable based on the plurality of business decisions and the time period. Additionally, the computer-implemented method may include presenting, using the processor, the at least one business variable.

In some embodiments, the computer-implemented method may further include presenting, using the processor, a user interface to a user. Further, the user interface may be configured to receive the plurality of business decisions.

In some embodiments, the user interface may be further configured to receive the time period.

In some embodiments, the plurality of business decisions may include data associated with at least two of tax, inventory, employees, a target Cost of Goods Sold (COGS), loan, expenses and revenue. Further, the at least one business variable may include one or more of a cash flow, a financial deficit, a tax bracket, at least one target Cost of Goods Sold (COGS) and at least one computed Cost of Goods Sold (COGS) associated with at least one product of the business.

In some embodiments, the computer-implemented method may further include, associating, using the processor, a plurality of categories to the plurality of business decisions. Further, the calculating may be performed based on the plurality of categories.

In some embodiments, the computer-implemented method may further include: analyzing, using the processor, each of the plurality of business decisions and the at least one business variable; and generating, using the processor, at least one suggested business decision based on analyzing the at least one business variable.

In some embodiments, the computer-implemented method may further include receiving, using the processor, at least one modified business decision. Further, calculating the at least one business variable may be further based on the at least one modified business decision.

In some embodiments, the at least one business variable may include a plurality of computed COGS corresponding to a plurality of products. Further, the plurality of computed COGS may be calculated based on a plurality of individual costs corresponding to the plurality of products and at least one shared cost corresponding to the plurality of products.

In some embodiments, the at least one business variable further may include an allowable maximum money expendable on direct materials associated with each product of the plurality of products.

In some embodiments, the computer-implemented method may further include generating, using the processor, a business plan corresponding to the business based on each of the plurality of business decisions, the time period and the at least one business variable.

In some embodiments, the computer-implemented method may further include: analyzing, using the processor, at least one document corresponding to the business; and extracting, using the processor, the plurality of business decision based on the analyzing.

In some embodiments, the computer-implemented method may further include: generating, using the processor, at least one query based on the plurality of business decisions; and executing the at least one query over at least one database including one or more of regulatory data and market data associated with the business. Further, calculating the at least one business variable may be based on a result of executing the at least one query.

Further, a system for facilitating a simulation of a business is provided. The system may include a communication device configured to receive a plurality of business decisions corresponding to the business. Further, the communication device may be configured to receive a time period corresponding to the simulation. Furthermore, the communication device may be configured to transmit at least one business variable. Additionally, the system may include a processing device configured to calculate the at least one business variable based on the plurality of business decisions and the time period.

In some embodiments, the communication device may be further configured to transmit a user interface to a user. Further, the user interface may be configured to receive the plurality of business decisions.

In some embodiments, the user interface may be further configured to receive the time period.

In some embodiments, the plurality of business decisions may include data associated with at least two of tax, inventory, employees, a target Cost of Goods Sold (COGS), loan, expenses and revenue. Further, the at least one business variable may include one or more of a cash flow, a financial deficit, a tax bracket, at least one target Cost of Goods Sold (COGS) and at least one computed Cost of Goods Sold (COGS) associated with at least one product of the business.

In some embodiments, the processing device may be further configured to associate a plurality of categories to the plurality of business decisions. Further, calculation of the at least one business variable may be performed based on the plurality of categories.

In some embodiments, the processing device may be further configured to: analyze each of the plurality of business decisions and the at least one business variable; and generate at least one suggested business decision based on analyzing the at least one business variable.

In some embodiments, the communication device may be further configured to receive at least one modified business decision. Further, the processing device may be configured to calculate the at least one business variable further based on the at least one modified business decision.

In some embodiments, the at least one business variable may include a plurality of computed COGS corresponding to a plurality of products. Further, the plurality of computed COGS may be calculated based on a plurality of individual costs corresponding to the plurality of products and at least one shared cost corresponding to the plurality of products.

In some embodiments, the at least one business variable further may include an allowable maximum money expendable on direct materials associated with each product of the plurality of products.

In some embodiments, the processing device may be further configured to generate a business plan corresponding to the business based on each of the plurality of business decisions, the time period and the at least one business variable.

In some embodiments, the processing device may be further configured to: analyze at least one document corresponding to the business, and extract the plurality of business decision based on the analyzing.

In some embodiments, the processing device may be further configured to generate at least one query based on the plurality of business decisions. Further, the communication device may be further configured to transmit the at least one query to at least one database and receive a result of executing the at least one query. Further, calculating the at least one business variable may be based on a result of executing the at least one query.

In some embodiments, a computer program (named, BSim™) designed specifically for entrepreneurs is provided. The computer program may be designed to replace pro forma financial projections. The computer program may simulate the actual financial processes that occur within a small business. Therefore, the computer program may provide critically important information to anyone wishing to write a business plan, as only a simulation can produce the realistic and actionable financial objectives that business plans should be based upon. Further, only realistic financials can give birth to realistic business plans. The computer program may be configured to properly recognize and account for diverse financial data. The output of the computer program may allow an entrepreneur to recognize and evaluate tradeoffs that only she has the best knowledge of.

According to further embodiments, the computer program may calculate Cost of Goods Sold (COGS). Further, the computer program may calculate the COGS for the overall business. Further, the computer program may calculate COGS for multiple independent products. Before a business is launched, it is crucial that the entrepreneur knows the true cost of their product(s). Very few entrepreneurs know the true cost of producing their product or service. This is one of the primary reasons that new products fail and new businesses die. The computer program calculates COGS based on the user's data inputs. If the user changes any of those inputs at any time, the computer program may change the COGS accordingly. Further, the computer program may provide the user with the maximum amount of funds that may be spent on the product's direct materials.

According to further embodiments, the computer program may be configured to allow users to view all the calculations. Therefore, all calculations may be visible on different sheets. Therefore, they may be available to accountants, bankers and venture capitalists to validate the assumptions and results.

According to further embodiments, the computer program may be configured to generate and update 5-year integrated financial sheets (an income statement to a cash-flow statement to a balance sheet). Each calculation in the income statement may trigger a calculation that appears in the cash-flow statement, which, in-turn may trigger a calculation that appears on the balance sheet.

According to further embodiments, the computer program may be configured to adhere to GAAP (Generally Accepted Accounting Principles). In other words, the computer program may be fully compliant with GAAP; therefore, its calculations may be trusted.

According to further embodiments, the computer program may include an opening day balance sheet. The computer program may integrate with an existing business.

According to further embodiments, the computer program may simulate a business providing multiple products; for example, 10 independent products. The cash-flows in and cash-flows out resulting from each product may be accounted for in the simulation.

According to further embodiments, the computer program may separately calculate COGS for each product or service. Every product or service produced and sold by a business carries its own costs to produce it and sell it. Some of these costs may be shared and some may be unique. The computer program accurately accounts for the COGS of each product and distributes all shared costs. This ensures that the business owner is aware of the actual costs to produce each of their products, so that they can assess their profitability.

According to further embodiments, the computer program may accurately calculate each component of COGS for each product. According to GAAP, the COGS is the sum of all of the costs necessary to produce and sell a product or service. That includes the price of the raw materials, the freight to bring it in, the cost of the labor, the depreciation of the machines used to produce it, the mileage to deliver it and more. The computer program accounts for all of these costs. Further, the business owners may identify methods of cost reduction during subsequent years, or the price of raw materials may change, or the cost of labor may increase from year to year. If this happens, the COGS of a product will change. Accordingly, the computer program may allow the user to change the COGS of each product or service from year-to-year. The COGS may be changed each year and for each product.

According to further embodiments, the computer program may accurately calculate the allowable maximum dollar value of direct materials for each product. COGs may include multiple components such as direct materials, direct labor and overhead. The computer program may take all the other components into account and determine how much can be spent on the direct materials of each product. If the business owner cannot purchase them for that amount, then they may then adjust the other components of COGS until that cost is acceptable.

According to further embodiments, the computer program may automatically or manually distribute the total COGS to all products. If one group of people (at a business) produce several different products, this labor cost must be accurately distributed to all those products. It is not accurate to simply divide the labor cost by the number of products because one product may require more time to produce than another. The computer program may automatically distribute this labor to all the products that a business produces so that the business owner has an accurate understanding of the true COGS. If the business owner knows the actual portion of COGS that each product demands, the computer program may allow the user to enter those percentages manually. This level of accuracy is a feature that a small business needs to form truly representative business financials.

According to further embodiments, the computer program may allow inventories to be input and calculated in either dollar amounts or units. Depending on the products that a business owner manufactures and sells, the business may be more accurately simulated by representing the inventory in terms of units. The business transforms unfinished materials into finished materials, it may be more accurate to use dollar amounts. The computer program allows the user to select how to calculate inventories. An accurate representation of a business will reduce the risk of failure.

According to further embodiments, the computer program may allow a user to set inventory limits and inventory reorder quantities. The computer program may allow the user to set upper and lower inventory limits. As inventory is consumed, the program may repurchase it according to limits set by the user. Inventory purchases have a great effect on cash flows and cash balances. They also appear as an asset item on the balance sheet. The computer program helps prevent issues like the business being unable to deliver a product or service that someone has paid for in advance because enough cash to purchase the required raw materials is not available.

According to further embodiments, the computer program may calculate social security, Medicare, and workman's compensation expenses. The cash outflows may be large and therefore can greatly affect the profitability of a business. Small business owners may think that their net income is high only to discover that they haven't taken these expenses into account. It's essential that they be calculated and included in their decision-making process. The computer program automatically calculates social security taxes, Medicare taxes and workman's compensation payments. Further, the computer program automatically calculates Federal Unemployment Tax Act (FUTA) and State Unemployment Tax Act (SUTA) taxes for all three workforce categories. The computer program may allow wage thresholds and tax rates for FUTA, SUTA and FICA to be changed each year.

According to further embodiments, the computer program may adhere to IRS Form 946 MACRS depreciation deduction schedules. The depreciation is one of the most important contributors to the profitability of a business. No financial plan can be considered accurate without taking depreciation into account. Further, depreciation is also a component of COGS. The computer program may allow the user to purchase depreciable assets during any month and depreciate them according to the IRS 946 MACRS method. This method is much more beneficial to the profitability of a business than the simple Straight Line method.

According to further embodiments, the computer program may allow users to elect to delay depreciation of assets during any month of the time period being simulated. Certain business activities wherein depreciable assets are being constructed will not depreciate these assets until they are fully constructed and made available for revenue generation. Therefore, users can simulate a delay in depreciation until such time as it is required.

According to further embodiments, the computer program may maintain a low-level cash balance limit set by the user. New, successful startups burn through a lot of cash in their early stages. And the worst thing that can happen to a successful small business is to run short of cash. If they are unable to pay their vendors, they may turn the business over to a collector. If they are unable to pay their employees, they may quit and they may discourage others from working for the business. The computer program may allow the user to set a low cash limit. If business activity is such that it causes the cash amount to fall below this value, the program may automatically borrow money. After the simulation has been completed, the amount that the business had to borrow to maintain the low-limit value serves as the line of credit that the business needs to pursue. Accurate representations of such processes are critical for new startups.

According to further embodiments, the computer program may provide three different methods of projecting monthly sales for each product. Research may reveal sales growth in terms of percentage increases. Further, the business dynamics may be better represented by units instead of dollars. The computer program may allow for three types of monthly sales projection:
Monthly sales in term of dollars
Monthly sales in terms of units
Monthly sales in terms of percent increase or decrease

According to further embodiments, the computer program may age revenues over 30, 60 or 90 days. computer program may allow the user to select the percentages of sales that are collected within 30, 60 or 90 days. Any sale not collected after 90 days may be considered bad debts. Business realities like these significantly impact the profitability of a small business.

According to further embodiments, the computer program may allow a user to select the business's fiscal year to begin on any month of any year. Most bankers and business consultants want to see financials projected out over a three to five-year period. This means that the names of from 36 to 60 months must be entered into a spreadsheet. With the computer program, the user only needs to enter the beginning month and the beginning year. All other months may be automatically populated.

According to further embodiments, the computer program may purchase and amortize deposits and prepaid expenses during any month. If a set of business financials is to be considered accurate, it must take into account all processes and all cash-flows. This includes deposits and prepaid expenses. Insurance is a prepaid expense. Utilities and rented property require deposits. With the computer program, the user may submit deposits or purchase prepaid expenses during any month. Not only that, the user may elect to have the prepaid expense automatically renew itself. The computer program takes these cash flows into account when generating financial projections. Prepaid expenses and deposits apply for both production or non-production purposes. If not accounted for properly, this can have an enormous impact on the profitability of a small business. The computer program may ensure that this difference is accounted for properly. Without this, the accuracy of the financials may be severely diminished.

According to further embodiments, the computer program may allow the user to borrow money during any month. The user may choose to borrow money at any interest rate. And at the end of each year, the computer program may display the total amount borrowed in both short term and long term loans and their outstanding principals. Accurate information is a key risk-reducing factor.

According to further embodiments, the computer program may allow users to elect to retire short-term loans at the beginning of each year if sufficient cash is available. At the beginning of each year, the computer program may provide information about the outstanding balances on all short-term loans. It may also show you the available cash balance. If there is enough cash to pay off some (or all) of these loans, the computer program may try it and see if it harms the business over the long term. If it doesn't, then those loans may be retired and the balance sheet may be strengthened.

According to further embodiments, the computer program may allow users to elect to retire long-term loans during any month of the time period being simulated. If there is enough cash to pay of some or all of the long-term loans, the computer program may try to pay off the loans to see if it harms the business over the long term. If the business is not harmed, then those loans may be retired and the balance sheet may be strengthened.

According to further embodiments, the computer program may include returns and allowances. The computer program may allow business owners to build in the returns and allowances as well as account for it correctly so that the financials accurately represent the business.

According to further embodiments, the computer program may allow a business owner to employ as many as 50 administrative and direct labor employees. Seven of them may be reserved for administrative (or non-production) activities. The other 43 may be available for production of your product or service. The business owner may choose to pay them via a salary or hourly wages. For hourly workers, the business owner may change their weekly hours. And if they work more than 40 hours per week, the computer program may calculate overtime automatically. If the business is seasonal, the business owner may remove their salaries from the calculations for as many months that apply. Further, they may designate any employee as either fulltime or part time.

According to further embodiments, the computer program may allow the business owner to create and employ a sales force along with any associated sales management. The business owner may be able to create a sales force with the following attributes:
1 Sales Director
6 Sales Regions
6 Regional Managers
6 Salespeople per Region (36 sales people)

The business owner may select any sales employee to be 1099. And just like any employee, the business owner may choose to pay them via a salary or hourly wages. Further, the business owner may choose to pay a sales commission. The business owner may choose to pay it monthly, quarterly, semi-annually or annually.

According to further embodiments, the computer program may allow investors to invest money during any month of any year. Therefore, if an investor comes along just when a business needs one, then the business owner may inject that investment when it's actually received. With this feature, the cash flow statement reflects the actual process.

According to further embodiments, the computer program may provide 6 sheets of additional financial details per year including break-even analysis. If the business owner expects to receive a loan to launch or grow your small business, their chances are far greater if they can show the banker how they arrived at the results. The computer program may clearly show all the calculations that were made. The banker may quickly see that they adhere to GAAP and can be trusted. He can even change any assumption and see the results instantly. He may want to test a different or additional scenarios.

According to further embodiments, the computer program may allow a user to assign business structure from 9 different selections. According to the selection made, the computer program may determine if SSN or FEIN is required. According to the selection made, the computer program may determine if Franchise and Excise Taxes must be paid.

According to further embodiments, the computer program may allow a user to assign the business' classification from 15 different selections. According to the selection made, the computer program may determine the Business Tax liability of the business.

According to further embodiments, the computer program may allow a user to select whether the business will sell Tangible Personal Property (TPP). According to the selection made, the computer program may prompt the user to gives percentages of sales within sales price ranges. According to the percentages entered, the computer program may assign the applicable sales tax rate to the sale of each item.

According to further embodiments, the computer program may allow a user to select whether the business will sell TPP that sells for a price that is greater than or equal to a price determined by the state. According to the selection made, the computer program may assign the applicable sales tax rate to the sale of each item.

According to further embodiments, the computer program may calculate the following state taxes sales & use tax, business tax, franchise tax and excise tax. The computer program may cause each expense to be incurred in the correct month and will credit the firm's cash in the correct month. These months may not be the same. The computer program may automatically determine if the Franchise & Excise tax must be paid quarterly or at the end of the firm's fiscal year.

According to further embodiments, the computer program may display, on a dedicated sheet, the value of each state taxes during the month that it was incurred. Further, the computer program may display, on a dedicated sheet, the payment of each state taxes during the month that it was paid. Yet further, the computer program may record a “Taxes Payable” entry on the balance sheet if any state taxes are not paid within the firm's fiscal year. Each product may be made exempt from sales tax on the sheet where projected sales is entered. Each product may be designated to be a food ingredient on the sheet where projected sales is entered and, therefore, be made subject to a different tax rate. Land purchases may be recorded during any month of the simulation. Intangibles expenses may be recorded and amortized during any month of the simulation. As many as 32 Administrative and Direct Labor employees may be designated 1099 contract employees. As many as 32 Administrative and Direct Labor employees may be exempted from FUTA/SUTA Taxes.

According to further embodiments, the computer program may display the following for each preceding fiscal year: operating cash flows, free cash flows, ending cash balance, ending loan balance, opportunity to enter a buyer's cost of capital, business valuation based on the buyer's cost of capital.

According to further embodiments, at the end of each Yearly simulation, the computer program may display monthly values of land purchases, monthly long-term loans, equity investments, major asset purchases, minor asset purchases, dividends paid, total monthly salaries, monthly expenses growth rate.

According to further embodiments, at the end of each Yearly simulation, the computer program may display values of initial inventory purchases, a cost of goods sold of each product, sales growth rate of each product.

According to further embodiments, at the beginning of years 2 thru 5, the computer program may provide to the user the opportunity to copy all operating parameter selections from the previous year via one check box selection. The computer program provides a highly convenient and simple method of filling in the remaining years of the simulation after year 1 is completed. The user can also enter an annual inflation rate.

According to further embodiments, the computer program may provide for each product in years 2 thru 5, the opportunity for the user to copy the sales from the previous year. The user may also enter a growth rate to be applied to the previous year so that increased (or decreased) sales projections can be entered. The computer program provides a highly convenient and simple method of filling in the sales projections of the remaining years.

According to further embodiments, the computer program may allow business owners to perform one or more of the following:
a. Simulate their new idea to determine if it is profitable based on realistic assumptions rather than guesses and simple assumed percentage increases.
b. Simulate the launch of a new product based on their usual and customary spending patterns to determine if it will be profitable and the length of time required.
c. “What-if” scenarios on their historical financial performance to determine any returns that may be available when financial variables are changed.
d. Determine if the funding of new ventures best occurs via debt financing, equity financing or internal financing.
e. Determine targets for financial variables such as cost of goods sold (COGS), sales & marketing, travel & entertainment, etc.
f. Reallocate COGS manually to adjust product prices so that its price competitiveness is maintained or enhanced.
g. Determine a break-even dollar amount and compare it to their current financial performance to determine agreement.
h. Simulate borrowing money and purchasing capital assets each month of each year to investigate the impact on short-term borrowing or EBIT.
i. Determine the actual required line of credit rather than assuming a required line of credit.
j. Make selections during the first year that matches uncertainties and limitations faced by the new start-up. The user can decide which month the owner will begin receiving a salary, the sales of each product will begin, certain expenses will begin, any rents will begin and other selections.
k. Determine their year-end balance sheets based on the true integration of the income statement, cash flow statement and COGS decisions.
l. Visibly observe yearly financial performance through an included Break-Even analysis chart.
m. Quickly view net income, EBIT, EBITDA, interest expense, income tax expense, current ratio and debt-to-assets ratio.
n. View the company balance sheet after all first-year selections have been made but before production begins.

Although the invention has been explained in relation to its preferred embodiment, it is understood that many other possible modifications and variations can be made without departing from the spirit and scope of the invention as herein described.

I/we claim:

1. A computer-implemented method of facilitating a simulation of a business, the computer-implemented method comprising:
receiving, using a processor, a plurality of business decisions corresponding to the business;
receiving, using the processor, a time period corresponding to the simulation;
calculating, using the processor, at least one business variable based on the plurality of business decisions and the time period; and
presenting, using the processor, the at least one business variable.

2. The computer-implemented method of claim 1 further comprising presenting, using the processor, a user interface to a user, wherein the user interface is configured to receive the plurality of business decisions.

3. The computer-implemented method of claim 2, wherein the user interface is further configured to receive the time period.

4. The computer-implemented method of claim 1, wherein the plurality of business decisions comprises data associated with at least two of tax, inventory, employees, Cost of Goods Sold (COGS), loan, expenses and revenue, wherein the at least one business variable comprises at least one of a cash flow, a financial deficit, a tax bracket and at least one Cost of Goods Sold (COGS) associated with at least one product of the business.

5. The computer-implemented method of claim 1 further comprising, associating, using the processor, a plurality of categories to the plurality of business decisions, wherein the calculating is performed based on the plurality of categories.

6. The computer-implemented method of claim 1 further comprising:
analyzing, using the processor, each of the plurality of business decisions and the at least one business variable; and
generating, using the processor, at least one suggested business decision based on analyzing the at least one business variable.

7. The computer-implemented method of claim 1 further comprising receiving, using the processor, at least one modified business decision, wherein calculating the at least one business variable is further based on the at least one modified business decision.

8. The computer-implemented method of claim 1, wherein the at least one business variable comprises a plurality of COGS corresponding to a plurality of products, wherein the plurality of COGS is calculated based on a plurality of individual costs corresponding to the plurality of products and at least one shared cost corresponding to the plurality of products.

9. The computer-implemented method of claim 8, wherein the at least one business variable further comprises an allowable maximum money expendable on direct materials associated with each product of the plurality of products.

10. The computer-implemented method of claim 1 further comprising generating, using the processor, a business plan corresponding to the business based on each of the plurality of business decisions, the time period and the at least one business variable.

11. The computer-implemented method of claim 1 further comprising:
analyzing, using the processor, at least one document corresponding to the business; and
extracting, using the processor, the plurality of business decision based on the analyzing.

12. The computer-implemented method of claim 1 further comprising:
generating, using the processor, at least one query based on the plurality of business decisions; and
executing the at least one query over at least one database comprising at least one of regulatory data and market data associated with the business, wherein calculating the at least one business variable is based on a result of executing the at least one query.

13. A system for facilitating a simulation of a business, the system comprising:
a communication device configured to:
receive a plurality of business decisions corresponding to the business;
receive a time period corresponding to the simulation;
transmit at least one business variable; and
a processing device configured to calculate the at least one business variable based on the plurality of business decisions and the time period.

14. The system of claim 13, wherein the communication device is further configured to transmit a user interface to a user, wherein the user interface is configured to receive the plurality of business decisions.

15. The system of claim 14, wherein the user interface is further configured to receive the time period.

16. The system of claim 13, wherein the plurality of business decisions comprises data associated with at least two of tax, inventory, employees, Cost of Goods Sold (COGS), loan, expenses and revenue, wherein the at least one business variable comprises at least one of a cash flow, a financial deficit, a tax bracket and at least one Cost of Goods Sold (COGS) associated with at least one product of the business.

17. The system of claim 13, wherein the processing device is further configured to associate a plurality of categories to the plurality of business decisions, wherein calculation of the at least one business variable is performed based on the plurality of categories.

18. The system of claim 13, wherein the processing device is further configured to:
analyze each of the plurality of business decisions and the at least one business variable; and
generate at least one suggested business decision based on analyzing the at least one business variable.

19. The system of claim 13, wherein the communication device is further configured to receive at least one modified business decision, wherein the processing device is configured to calculate the at least one business variable further based on the at least one modified business decision.

20. The system of claim 13, wherein the at least one business variable comprises a plurality of COGS corresponding to a plurality of products, wherein the plurality of COGS is calculated based on a plurality of individual costs corresponding to the plurality of products and at least one shared cost corresponding to the plurality of products.

21. The system of claim 20, wherein the at least one business variable further comprises an allowable maximum money expendable on direct materials associated with each product of the plurality of products.

22. The system of claim 13, wherein the processing device is further configured to generate a business plan corresponding to the business based on each of the plurality of business decisions, the time period and the at least one business variable.

23. The system of claim 13, wherein the processing device is further configured to:
analyze at least one document corresponding to the business; and
extract the plurality of business decision based on the analyzing.

24. The system of claim 13, wherein the processing device is further configured to generate at least one query based on the plurality of business decisions, wherein the communication device is further configured to transmit the at least one query to at least one database and receive a result of executing the at least one query, wherein calculating the at least one business variable is based on a result of executing the at least one query.
